(19) United States
(12) Patent Application Publication
(10) Pub. No.: US 2001/0048251 A1
(43) Pub. Date: Dec. 6, 2001

(54) Electric compressor

(76) Inventor: Shoichi Ieoka, Kariya-shi (JP)

Correspondence Address: MORGAN & FINNEGAN, L.L.P., 345 Park Avenue, New York, NY, 10154, US

(21) Appl. No.: 09/823,880

(22) Filed: Mar. 30, 2001

(30) Foreign Application Priority Data
Mar. 31, 2000 (JP) 2000-096726

(51) Int. Cl. H02K 37/00; H02K 1/12

(52) U.S. Cl. 310/49 R; 310/257; 310/112

(57) ABSTRACT

An electric compressor includes a compression mechanism and an electric motor. The compression mechanism compresses gas. The electric motor has a rotary shaft that is coupled to the compression mechanism. The compression mechanism and the electric motor are integrally assembled. The electric motor is a ring coil type motor in which a coil is wounded in the circumferential direction of the rotary shaft.

### BACKGROUND OF THE INVENTION

The present invention relates to an electric compressor in which a compression mechanism for compressing gas is driven by an electric motor.

Japanese Unexamined Patent Publication No. 2-248660 discloses an electric compressor 71, which is shown in FIG. 8. The compressor 71 includes a piston type compression mechanism 72 and an electric motor 73 that drives the compression mechanism 72. The compression mechanism 72 includes a swash plate 77 and pistons 78. The motor 73 has stators 74 and a rotor 75. A rotary shaft 76, which rotates integrally with the rotor 75, is coupled to the compression mechanism 72. The swash plate 77 rotates integrally with the rotary shaft 76 and reciprocates the pistons 78.

The motor 73 is an induction motor or a synchronous motor. Synchronous motors include surface permanent magnet type motors and internal permanent magnet type motors. A coil 79 is wound about each stator 74 and is parallel to the axis of the rotary shaft 76.

Regardless of whether the motor 73 is an induction type or synchronous type, each coil 79 has sticking portions 79a. Therefore, each stator 74 is longer than the rotor 75 in the axial direction. In other words, the axial dimension of the motor 73 is relatively large. This increases the size of the compressor 71.

The compression mechanism 72 is coupled to the rotary shaft 76, which extends outward (leftward as viewed in FIG. 8) from the motor 73. Therefore, when the thermal load increases or when the speed of the motor 73 is increased, the rotary shaft 76 is likely to be vibrated in the torsional direction. Such vibrations affect the operational timing of the compression mechanism 72. For example, the torsional vibrations generate pulsations of gas discharged by the compression mechanism 72.

### BRIEF SUMMARY OF THE INVENTION

Accordingly, it is an objective of the present invention to provide a compact electric compressor that reliably operates.

To achieve the foregoing and other objectives and in accordance with the purpose of the present invention, an electric compressor that includes a compression mechanism for compressing gas and an electric motor that has a rotary shaft is provided. The rotary shaft is coupled to the compression mechanism. The compression mechanism and the electric motor are integrally assembled. The electric motor is a ring coil type motor in which a coil is wound in the circumferential direction of the rotary shaft.

Other aspects and advantages of the invention will become apparent from the following description, taken in conjunction with the accompanying drawings, illustrating by way of example the principles of the invention.

### BRIEF DESCRIPTION OF THE SEVERAL VIEWS OF THE DRAWING

The invention, together with objects and advantages thereof, may best be understood by reference to the following description of the presently preferred embodiments together with the accompanying drawings in which:

FIG. 1 is a cross-sectional view illustrating an electric compressor according to a first embodiment of the present invention;

FIG. 2(a) is a perspective view, with a part cut away, illustrating the electric motor of the compressor shown in FIG. 1;

FIG. 2(b) is a cross-sectional view taken along line 2b-2b of FIG. 2(a);

FIG. 3 shows waveforms of current supplied to the motor shown in FIG. 1;

FIG. 4 is a cross-sectional view illustrating an electric compressor according to a second embodiment;

FIG. 5 is a perspective view, with a part cut away, illustrating the electric motor of the compressor shown in FIG. 4;

FIG. 6 is a cross-sectional view illustrating an electric compressor according to a third embodiment;

FIG. 7 is a cross-sectional view illustrating an electric compressor according to a fourth embodiment; and

FIG. 8 is a cross-sectional view illustrating a prior art electric compressor.

### DETAILED DESCRIPTION OF THE PREFERRED EMBODIMENTS

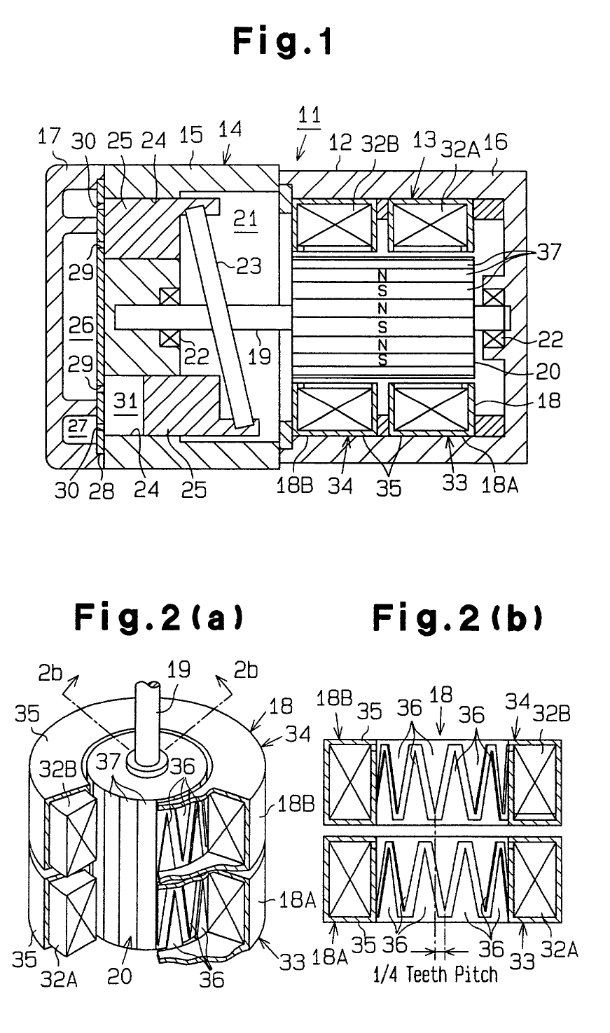

A first embodiment of the present invention will be described with reference to FIGS. 1 to 3.

As shown in FIG. 1, a housing 12, an electric compressor 11 includes an inner rotor type electric motor 13 and a fixed displacement type compression mechanism 14. The compressor 14 has a swash plate 23. The housing 12 includes a cylinder block 15, a motor housing member 16 coupled to the cylinder block 15 and a rear housing member 17.

The motor 13 includes a stator 18 located in the motor housing member 16 and a cylindrical rotor 20 fixed to a rotary shaft 19. The rotary shaft 19 is supported by the housing 12 through a pair of bearings 22. Part of the rotary shaft 19 extends through the cylinder block 15 and is coupled to the compression mechanism 14. The swash plate 23 is fixed to the rotary shaft 19 and is inclined by a predetermined angle. Several cylinder bores 24 are formed in the cylinder block 15. The cylinder bores 24 are spaced apart by predetermined angular intervals about the axis of the rotary shaft 19. Each cylinder bore 24 accommodates a piston 25, which is coupled to the peripheral portion of the swash plate 23 by shoes (not shown). When the rotary shaft 19 rotates, the swash plate 23 rotates integrally with the rotary shaft 19. Accordingly, each piston 25 is reciprocated in the associated cylinder bore 24.

A suction chamber 26 and a discharge chamber 27 are defined in the rear housing member 17. A valve plate 28 is located between the cylinder block 15 and the rear housing member 17. The valve plate 28 includes suction ports 29 and discharge port 30. Each suction port 29 corresponds to one of the cylinder bores 24 and each discharge port 30 corresponds to one of the cylinder bores 24. Each compression chamber 31 defined by the piston 25 and the valve plate 28 in each cylinder bore 24 is connected to the suction chamber 26 through the corresponding suction port 29. Each compression chamber 31 is connected to the discharge chamber 27 by the corresponding discharge port 30. Suction valve flaps and discharge flaps (neither is shown) are formed on the valve plate 28. Each suction valve flap corresponds to one of the suction ports 29. Each discharge valve flap corresponds to one of the discharge ports 30.

When each piston 25 moves from the top dead center to the bottom dead center, refrigerant gas is drawn into the associated compression chamber 31 from the suction chamber 26. When each piston 25 moves form the bottom dead center to the top dead center, refrigerant gas in the associated compression chamber 31 is compressed and then discharged to the discharge chamber 27. The discharge displacement of the compressor 11 is controlled by changing the speed of the motor 13. When the speed of the rotation of the motor 13 is lowered, the speed of each piston 25 is lowered accordingly, which decreases the displacement of the compressor 11. When the speed of the rotation of the motor 13 is increased, the speed of the reciprocation of each piston 25 is increased accordingly, which increases the displacement of the compressor 11.

As shown in FIGS. 1 to 2(b), the motor 13 includes first and second ring coils 32A, 32B, which are wound about the stator 18 along the circumferential direction of the stator 18, or along the circumferential direction of the rotary shaft 19. The motor 13 is a permanent magnet (PM) type craw-poled motor.

The motor 13 has multi stack structure. Specifically, the motor 13 has a two phase stack structure and includes, an A-phase coil member 33 and a B-phase coil member 34. The coil members 33, 34 are arranged axially around the rotor 20. The A-phase coil member 33 includes a first stator piece 18A. The B-phase coil member 34 includes a second stator piece 18B. Each of the stator pieces 18A, 18B includes a cylindrical stator housing 35. The first stator piece 18A has a first bifilar wound ring coil 32A, which is accommodated in the corresponding stator housing 35. The second stator piece 18B has a second bifilar wound ring coil 32B, which is accommodated in the corresponding stator housing 35. As shown in FIGS. 2(a) and 2(b), each stator housing 35 has craw poles (inductors) 36, the number of which is n. The craw poles 36 are located on the inner circumference of each stator housing 35 and arranged in two meshing rows. The angle θ of the teeth pitch (pole pitch) of the craw poles 36 is expressed by an equation θ=(360/n)°. As shown in FIG. 2(b), the craw poles 36 of the A-phase coil member 33 is displaced from the craw poles 36 of the B-phase coil member 34 in the circumferential direction by a quarter teeth pitch (step angle (θs/4). The polarity of the first and second ring coils 32A, 32B is the one that is generated when the first ring coil 32A or the second ring coil 32B is excited.

Ferrite magnets 37, the number of which is n, are located on the circumferential surface of the rotor 20. Each ferrite magnet 37 is magnetized to form a hetero polar magnet field. The number of the ferrite magnets 37 is equal to that of the craw pole 36. The step angle θs of the ferrite magnets 37 is expressed by an equation θs=(180/n)°.

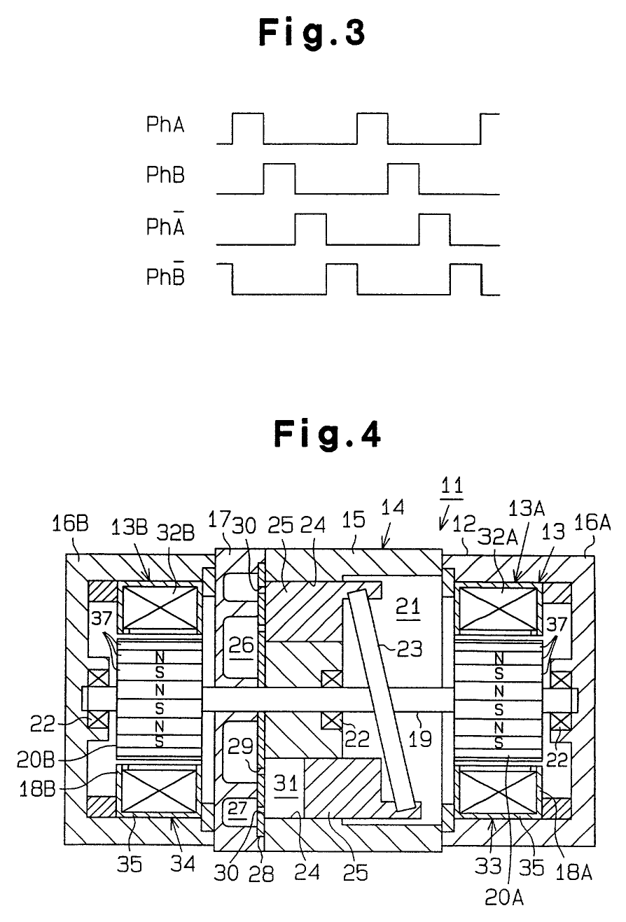

FIG. 3 shows waveforms of currents supplied to the first and second ring coils 32A, 32B. That is, the timing of exciting the first ring coil 32A and the second ring coil 32B is controlled as shown in FIG. 3. When the first and second ring coils 32A, 32B are excited, a hetero polar magnet field is generated about each craw pole 36 of the stator pieces 18A, 18B. The hetero polar magnet fields of the craw poles 36 and the hetero polar magnet fields of the ferrite magnets 37 generate rotational torque, which rotates the rotor 20.

The embodiment of FIGS. 1 to 3 has the following advantages.

The coils 32A, 32B do not have potions that stick out of the stator 18 in the axial direction. Therefore, the axial size of the motor 13 is relatively small, which reduces the size of the compressor 11. The motor 13 has a two phase stack structure. In other words, the motor 13 is actuated only by the two coil members 33, 34. Therefore, compared to multi-phase motors that have three or more coil members, the motor 13 is compact in the axial direction. The present invention is suitable for reducing the size of the compressor 11.

The first and second ring coils 32A, 32B are wound in a simple manner and have simple structures. Therefore, the ring coils 32A, 32B are easy to manufacture, which reduces the cost of the compressor 11.

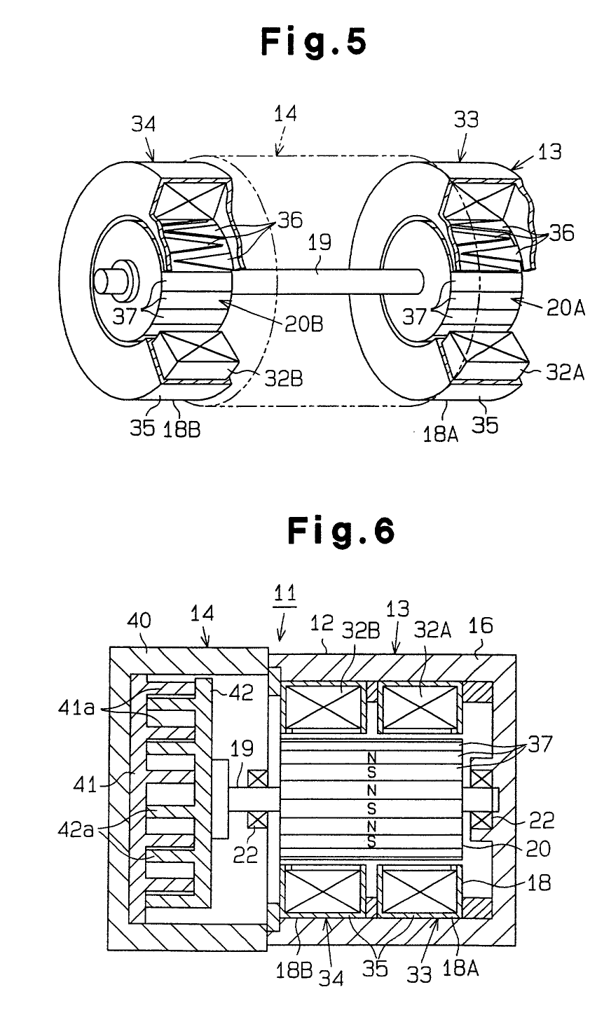

A second embodiment of the present invention will now be described with reference to FIGS. 4 and 5.

Like the motor 13 of the first embodiment shown in FIGS. 1 to 3, a motor 13 of the second embodiment is a PM type motor that has craw poles as shown in FIG. 4. The second embodiment is different form the first embodiment of FIGS. 1 to 3 in that the motor 13 is divided into two column portions each having a coil member 33, 34. The motor pieces are located at the ends of the compression mechanism 14, respectively. The differences from the embodiment of FIGS. 1 to 3 will mainly be discussed below, and like or the same reference numerals are given to those components that are like or the same as the corresponding components of the first embodiment of FIGS. 1 to 3.

The compression mechanism 14 is located at the axial center of the compressor 11. A housing 12 includes a cylinder block 15, a rear housing member 17 and two motor housing members 16A, 16B. The motor housing members 16A is joined to the cylinder block 15, and the motor housing member 16B is joined to the rear housing member 17.

Like the first embodiment of FIGS. 1 to 3, the motor 13 has an A-phase coil member 33 and a B-phase coil member 34. The A-phase coil member 33 is housed in the motor housing member 16A, and the B-phase coil member 34 is housed in the motor housing member 16B. The A-phase coil member 33 includes a stator piece 18A. A cylindrical rotor 20A, which is fixed to a rotary shaft 19, is located radially inside of the A-phase coil member 33. The B-phase coil member 34 includes a stator piece 18B. A cylindrical rotor 20B, which is fixed to the rotary shaft 19, is located radially inside of the B-phase coil member 34. The rotors 20A, 20B are the same as the rotor 20 of FIGS. 1 to 2(b) except that the axial dimension is half of the rotor 20. Ferrite magnets 37, the number of which is n, are located on the circumferential surface of each the rotor 20A, 20B. Each ferrite magnet 37 is magnetized to create a hetero polar magnetic field.

Each stator piece 18A, 18B is radially outside of the corresponding rotor 20A, 20B. The rotary shaft 19 extends through the center of the compression mechanism 14, which is located in the crank chamber 21 and is supported by the housing members 16A, 16B through several bearings 22. Like the compression mechanism 14 shown in FIGS. 1 to 3, the compression mechanism 14 of FIG. 4 is a fixed displacement swash plate type. A suction chamber 26 and a discharge chamber 27 are defined in the rear housing member 17. A swash plate 23 rotates integrally with the rotary shaft 19. Rotation of the swash plate 23 is converted into reciprocation of each piston 25 in the corresponding cylinder bore 24. As the pistons 25 reciprocate, refrigerant is compressed and the compression mechanism 14 operates at a displacement that corresponds to the speed of the rotary shaft 19.

In addition to the advantages of the embodiment shown in FIGS. 1 to 3, the embodiment of FIGS. 4 and 5 has the following advantages.

The coil members 33, 34 are located at both ends of the compression mechanism 14. Therefore, rotational force of the motor 13 is transmitted to the compression mechanism 14 from both ends. Thus, compared to the compressor 11 of FIGS. 1 to 3, in which force is applied to the compression mechanism 14 from only one end, changes of the thermal load and changes of speed of the rotary shaft 19 are less likely to torsionally vibrate the rotary shaft 19, which reduces pulsation of discharged gas due to torsional vibration of the rotary shaft 19.

The coil members 33, 34 of the motors 13 are located at the ends of the compression mechanism 14 and are separated from each other. Thus, heat generated in the coil members 33, 34 is efficiently radiated, which improves the radiating characteristics of the motor 13.

The coil members 33, 34 are located at the ends of the compression mechanism 14 and have the symmetrical structure. Therefore, rotational forces from the coil members 33, 34 are substantially balanced, which effectively suppresses the torsional vibration of the rotary shaft 19.

A third embodiment of the present invention will now be described with reference to FIG. 6. Unlike the embodiments of FIGS. 1 to 5, a compressor 11 of FIG. 6 has a scroll type compression mechanism 14. The scroll type compression mechanism 14 includes a stationary scroll 41 and a movable scroll 42, which are located in a rear housing member 40. The stationary scroll 41 includes a stationary volute portion 41a. The movable scroll 42 includes a movable volute portion 42a. The volute portions 41a, 42a engage each other. When a craw pole motor 13 is actuated, the movable scroll 42, which is coupled to a rotary shaft 19, starts orbiting. As the movable scroll 42 orbits, pockets, which are defined between the volute portions 41a, 42a, move toward the inner ends of the volute portions 41a, 42a. As it moves, the volume of each pocket decreases, which compresses refrigerant gas. The embodiment of FIG. 6 has the same advantages as the embodiments of FIGS. 1 to 5.

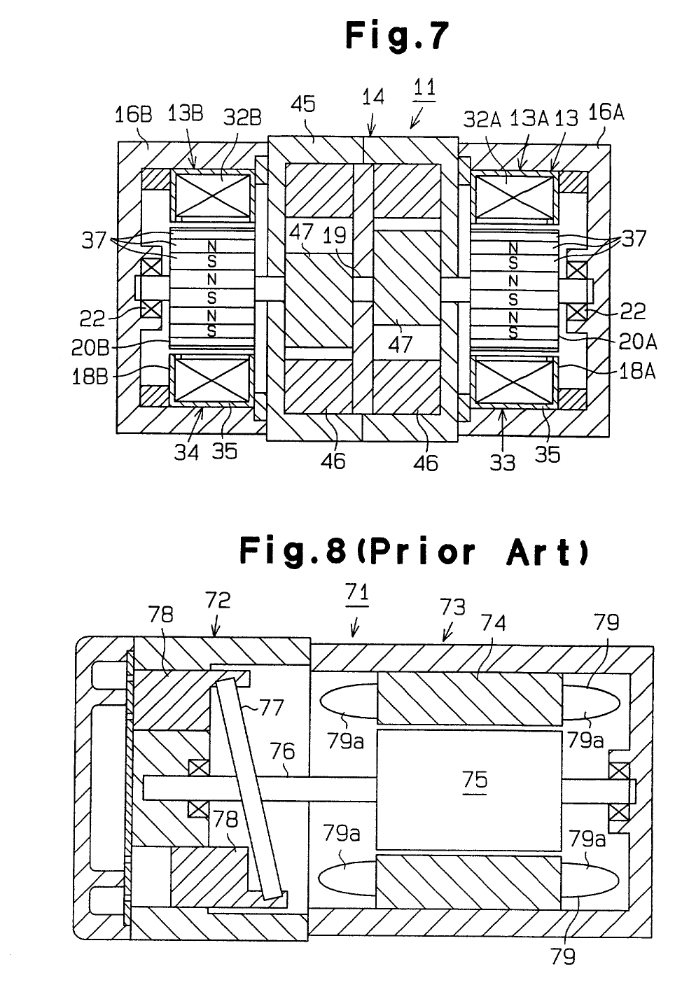

A fourth embodiment of the present invention will now be described with reference to FIG. 7. A compression mechanism 14 of FIG. 7 is a rotary type. The compression mechanism 14 includes a middle housing member 45. Two rotary cylinders 46 are housed in the middle housing member 45. Each rotary cylinder 46 has a rotor 47. Each rotor 47 rotates with a rotary shaft 19. Two coil members 33, 34 of a craw pole motor 13 are located at the ends of the compression mechanism 14, respectively. The embodiment of FIG. 7 has the same advantages as the embodiment of FIGS. 4 and 6.

It should be apparent to those skilled in the art that the present invention may be embodied in many other specific forms without departing from the spirit or scope of the invention. Particularly, it should be understood that the invention may be embodied in the following forms.

In the embodiments of FIGS. 4, 5 and 7, the single motor 13 is divided into two sections, which are located at the ends of the compression mechanism 14. If the compression mechanism 14 requires a relatively great force, two motors 13 may be located at the ends of the compression mechanism 14, respectively. In this case, torsional vibration of the rotary shaft 19 is reduces. Since each motor 13 is a rig coil type, the axial dimension of the compressor that has two motors 13 is smaller than that of the motor 73 shown in FIG. 8, which has coil end portion 79a.

The motor 13 is not limited to a craw pole motor as long as it is a ring coil type motor. A motor that has three or more axially arranged coil members may be used. For example, a motor that has several stack members may be used. Each stack member includes a pair stator disks and a ring coil located between the disks. Each stator disk has radially extending craw poles, and the teeth phase of the disks are displaced from each other. In this case, currents supplied to the stator disks have different waveforms.

When dividing a motor into two sections like the motor 13 of FIGS. 4 and 5, a motor other than craw pole motors may be used. That is, any motor that can be divided in the axial direction may be used. For example, a motor that has three or more coil members may be used. When a three phase coil type motor that has three coil members is used, one of the coil member is located at one end of the compression mechanism 14 and the remainder of the coil members are located at the other end of the compression mechanism 14. When a multi-phase motor that has even number of coil members is used, the number of coil members that are located at each side of the compression mechanism is preferably the same, so that forces applied to the compression mechanism from the ends are substantially balanced. This structure reduces torsional vibrations of the rotary shaft.

In the embodiments of FIGS. 1 to 5, a variable displacement swash plate type compression mechanism may be used.

In the embodiments of FIGS. 4 and 7, a vane type compression mechanism may be used.

A craw pole motor other than a PM type motor may be used.

The fluid that is compressed is not limited to refrigerant. The present invention may be applied to an electric compressor that used for purposes other than refrigeration.

Therefore, the present examples and embodiments are to be considered as illustrative and not restrictive and the invention is not to be limited to the details given herein, but may be modified within the scope and equivalence of the appended claims.

What is claimed is:

1. An electric compressor that includes a compression mechanism for compressing gas and an electric motor that has a rotary shaft, wherein the rotary shaft is coupled to the compression mechanism, wherein the compression mechanism and the electric motor are integrally assembled, and wherein the electric motor is a ring coil type motor in which a coil is wound in the circumferential direction of the rotary shaft.

2. The electric compressor according to claim 1, wherein the electric motor is a craw-poled motor.

3. The electric compressor according to claim 1, wherein the electric motor is one of a pair of electric motors, wherein the electric motors are located at both axial ends of the compression mechanism, respectively.

4. The electric compressor according to claim 1, wherein the electric motor has a plurality of column portions, and the coil is one of a plurality of coils, wherein each column portion has one of the coils, and wherein at least one of the column portions is located at one of the axial ends of the compression mechanism, and the remainder of the column portions are located at the other axial end of the compression mechanism.

5. The electric compressor according to claim 4, wherein the number of the column portions is two, and wherein column portions are symmetrical.

6. The electric compressor according to claim 4, wherein the numbers of the column portions located at both ends of the compression mechanism are the same.

7. The electric compressor according to claim 2, wherein the compression mechanism is any one of a swash plate type compression mechanism, a scroll type compression mechanism and a rotary type compression mechanism.

8. The electric compressor according to claim 3, wherein the compression mechanism is a swash plate type compression mechanism or a rotary type compression mechanism.

9. An electric compressor that includes a compression mechanism for compressing gas and a pair of electric motors that have a rotary shaft, wherein the rotary shaft is coupled to the compression mechanism, wherein the compression mechanism and the electric motors are integrally assembled, wherein each electric motor has a coil, wherein the coil is wound in the circumferential direction of the rotary shaft, and wherein the electric motors are located at both axial ends of the compression mechanism, respectively.

10. The electric compressor according to claim 9, wherein the electric motors are a ring coil type motor.

11. The electric compressor according to claim 9, wherein the electric motors are a craw-poled motor.

12. The electric compressor according to claim 9, wherein each electric motor has the same number of column portions, and the coils are two of a plurality of coils, wherein each column portion has one of the coils.
